(19) United States
(12) Patent Application Publication
(10) Pub. No.: US 2026/0154146 A1
(43) Pub. Date: Jun. 4, 2026

(54) HYBRID STRUCTURED AND UNSTRUCTURED DATA SEARCH FOR AUTOMATED ROOT CAUSE ANALYSIS

(71) Applicant: TOYOTA RESEARCH INSTITUTE, INC., Los Altos, CA (US)

(72) Inventors: Matthew P. GORDON, Berkeley, CA (US); Flora Miao CHEN, San Francisco, CA (US); Benjamin CHANG, San Francisco, CA (US); Arjun BHARGAVA, Brooklyn, NY (US); Robert Brian MASON, Irvine, CA (US); Kordel FRANCE, Allen, TX (US); Ravi Chandu UMMADISETTI, Plano, TX (US); Kuo Sung SWEI, Allen, TX (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/967,272

(22) Filed: Dec. 3, 2024

(51) Int. Cl. G06F 11/07

(52) U.S. Cl. CPC G06F 11/079; G06F 11/0709

(57) ABSTRACT

A method for automated root cause analysis via one or more structured data sources and one or more unstructured data sources includes identifying an error in a process or an environment. The method also includes searching the one or more unstructured data sources via a retrieval-augmented generation (RAG) component based on an error description corresponding to the identified error. The method further includes generating, via the RAG component, a hypothesis for the error in accordance with searching the one or more unstructured data sources. The method also includes searching the one or more structured data sources based on one or more queries generated via a text-to-SQL component in accordance with the hypothesis. The method still further includes autonomously adjusting one or more parameters of one or more devices associated with the process or the environment in accordance with searching the one or more structured data sources.

### FIELD OF THE DISCLOSURE

Aspects of the present disclosure relate generally to searching structured and unstructured data, and more specifically to automated root cause analysis via a hybrid structure and unstructured data search.

### BACKGROUND

Manufacturing environments tend to generate large volumes of data. This data may generally be divided into two categories: structured data and unstructured data. Both types of data may be used for monitoring, controlling, and improving manufacturing processes. Still, structured data and unstructured data differ in how they are organized, managed, and utilized.

Structured data refers to organized and easily searchable data, such as data that may be stored in a database. In manufacturing environments, the structured data may include, for example, sensor readings, such as temperature, pressure, and/or speed. The structured data may also include process parameters, such as machine settings and/or operating conditions. The structured data may further include quality measurements, such as dimensional checks, defect rates, and/or performance metrics. The structured data may also include numeric and/or categorical data. Accordingly, structured data may be suitable for storage in conventional relational databases, where the data may be queried and analyzed.

Unstructured data includes information that lacks a predefined format, such that the unstructured data is more difficult to search and analyze using conventional database methods. In manufacturing environments, unstructured data may include, for example, expert notes, equipment manuals, and/or troubleshooting guides. The examples may be in the form of lengthy, unformatted documents such as PDFs. Additionally, or alternatively, the unstructured data may be in free-text formats, such as text documents, emails, or forum posts.

### SUMMARY

In one aspect of the present disclosure, a method for automated root cause analysis via one or more structured data sources and one or more unstructured data sources includes identifying an error in a process or an environment. The method further includes searching the one or more unstructured data sources via a retrieval-augmented generation (RAG) component based on an error description corresponding to the identified error. The method also includes generating a hypothesis for the error via the RAG component in accordance with the search of the one or more unstructured data sources. The method further includes searching the one or more structured data sources based on one or more queries generated via a text-to-SQL component in accordance with the hypothesis. The method still further includes autonomously adjusting one or more parameters of one or more devices associated with the process or the environment in accordance with searching the one or more structured data sources.

Another aspect of the present disclosure is directed to an apparatus including means for identifying an error in a process or an environment. The apparatus further includes means for searching the one or more unstructured data sources via a retrieval-augmented generation (RAG) component based on an error description corresponding to the identified error. The apparatus also includes means for generating a hypothesis for the error via the RAG component in accordance with the search of the one or more unstructured data sources. The apparatus further includes means for searching the one or more structured data sources based on one or more queries generated via a text-to-SQL component in accordance with the hypothesis. The apparatus still further includes means for autonomously adjusting one or more parameters of one or more devices associated with the process or the environment in accordance with searching the one or more structured data sources.

In another aspect of the present disclosure, a non-transitory computer-readable medium with non-transitory program code recorded thereon is disclosed. The program code is executed by one or more processors and includes program code to identify an error in a process or an environment. The program code further includes program code to search the one or more unstructured data sources via a retrieval-augmented generation (RAG) component based on an error description corresponding to the identified error. The program code also includes program code to generate a hypothesis for the error via the RAG component in accordance with the search of the one or more unstructured data sources. The program code further includes program code to search the one or more structured data sources based on one or more queries generated via a text-to-SQL component in accordance with the hypothesis. The program code still further includes program code to autonomously adjust one or more parameters of one or more devices associated with the process or the environment in accordance with searching the one or more structured data sources.

Another aspect of the present disclosure is directed to an apparatus having one or more processors, and one or more memories coupled with the one or more processors and storing instructions operable, when executed by the processor, to cause the apparatus to identify an error in a process or an environment. Execution of the instructions further causes the apparatus to search the one or more unstructured data sources via a retrieval-augmented generation (RAG) component based on an error description corresponding to the identified error. Execution of the instructions also causes the apparatus to generate a hypothesis for the error via the RAG component in accordance with the search of the one or more unstructured data sources. Execution of the instructions further causes the apparatus to search the one or more structured data sources based on one or more queries generated via a text-to-SQL component in accordance with the hypothesis. Execution of the instructions still further causes the apparatus to autonomously adjust one or more parameters of one or more devices associated with the process or the environment in accordance with searching the one or more structured data sources.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of an integrated analysis system for automated root cause analysis, in accordance with aspects of the present disclosure.

FIG. 2 is a diagram illustrating an example of a hardware implementation for a device used in an integrated analysis system for automated root cause analysis, in accordance with aspects of the present disclosure.

FIG. 4 is a flow diagram illustrating an example process for automated root cause analysis via an integrated analysis system, in accordance with some aspects of the present disclosure.

FIG. 5 is a flow diagram illustrating an example process for automated root cause analysis via an integrated analysis system, in accordance with some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As discussed, large volumes of data may be associated with and/or produced from manufacturing environments and/or other environments. This data may generally be divided into two categories: structured data and unstructured data. Both structured data and unstructured data may be used for monitoring, controlling, and improving manufacturing processes, yet the types of data differ in how they are organized, managed, and utilized.

Structured data refers to organized and easily searchable information that may be stored in a database. Unstructured data may include information that lacks a predefined format, making it more difficult to search and analyze using traditional database methods. Examples of structured data include, but are not limited to, sensor readings, machine settings, or quality measurements, Examples of unstructured data include, but are not limited to, expert notes, equipment manuals, or troubleshooting guides.

In conventional systems, separate tools may be used to retrieve relevant information from structured data sources (e.g., structured databases) and data sources for expert insights. In such conventional systems, a human operator must bridge the gap between these tools by reading through data gathered from the unstructured data sources, forming a hypothesis based on the gathered data, and manually querying for additional data from the structured data sources to validate the hypothesis. This process is slow and requires significant expertise. Without an integrated system that can connect both structured and unstructured data sources, the goal of fully autonomous root cause analysis remains out of reach. Furthermore, the human operator may be limited by the sheer volume of data to process from numerous source, potential inconsistencies between structured and unstructured sources, and the need for specialized domain knowledge to interpret the results effectively. Additionally, manual processes are prone to human error, and the iterative nature of hypothesis testing and data gathering can be time-consuming, further hindering efficient problem-solving.

Various aspects of the present disclosure are directed to an integrated system that automates root cause analysis by combining structured and unstructured data into a unified process. In some examples, the system may use a trained model to autonomously search unstructured documents, generate a hypothesis, and validate the hypothesis via structured data without the need for manual intervention.

Particular aspects of the subject matter described in this disclosure can be implemented to realize one or more of the following potential advantages. In some examples, the described techniques of combining structured and unstructured data may automate and accelerate root cause analysis, reduce reliance on human expertise, improve accuracy by integrating data from multiple sources, and enable proactive identification of issues through continuous monitoring and analysis. Additionally, these techniques may facilitate more efficient decision-making by providing actionable insights and recommendations in real-time.

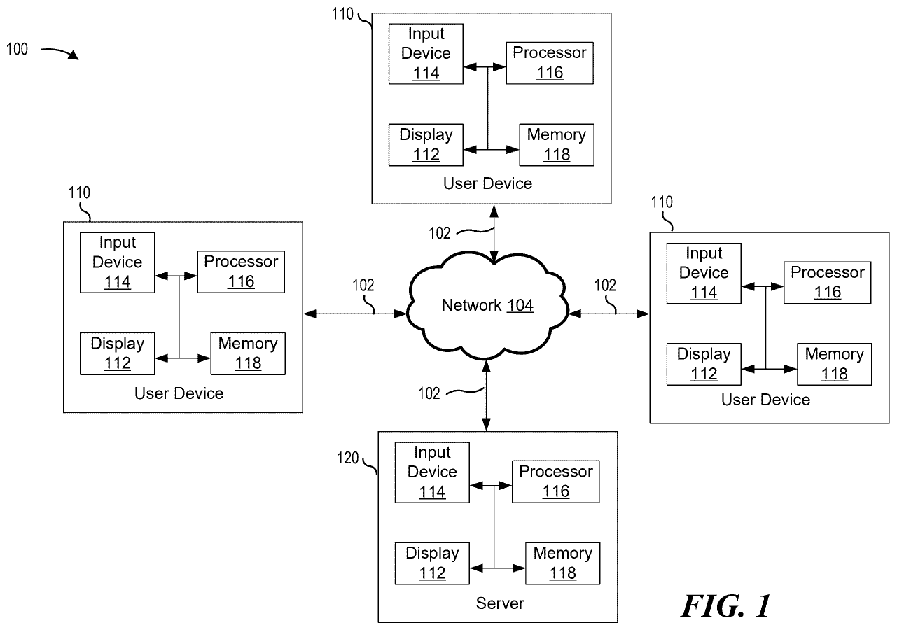

FIG. 1 is a block diagram illustrating an example of a system 100 for automated root cause analysis, in accordance with aspects of the present disclosure. The system 100 may be referred to as integrated analysis system. As shown in the example of FIG. 1, the system 100 may include one or more user devices 110 and one or more servers 120. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may include network links, dial-up links, wireless links (e.g., Wi-Fi link, satellite link, or cellular communication link), and/or hard-wired links.

The server 120 may be a computing device, such as a server, processor, computer, cloud computing device, or any other suitable device that is configured to search structured and/or unstructured data sources, and perform automated root cause analysis, in accordance with various aspects of the present disclosure. In some examples, the server 120 may host one or more machine learning models for searching structured and/or unstructured data sources, and performing automated root cause analysis, in accordance with various aspects of the present disclosure. Specifically, the server 120 may implement functions and/or computer code that searches structured and/or unstructured data sources, and performs automated root cause analysis, in accordance with various aspects of the present disclosure. Additionally, or alternatively, the server

Each user device 110 may be an example of a personal computing device, a smartphone, or any other device capable of interacting with the system via wired or wireless communication. A user device 110 may be used by a user to search structured and/or unstructured data sources, and perform automated root cause analysis, in accordance with various aspects of the present disclosure. Additionally, or alternatively, the user device 110 may include components for storing structured and/or unstructured data. In some examples, each user device 110 shown in FIG. 1 may be used by a different user. Each user device 110 and server 120 may be stationary or mobile.

In some examples, each user device 110 may be included inside a housing that contains components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the QR code encryption model and/or provide feedback regarding data encoding.

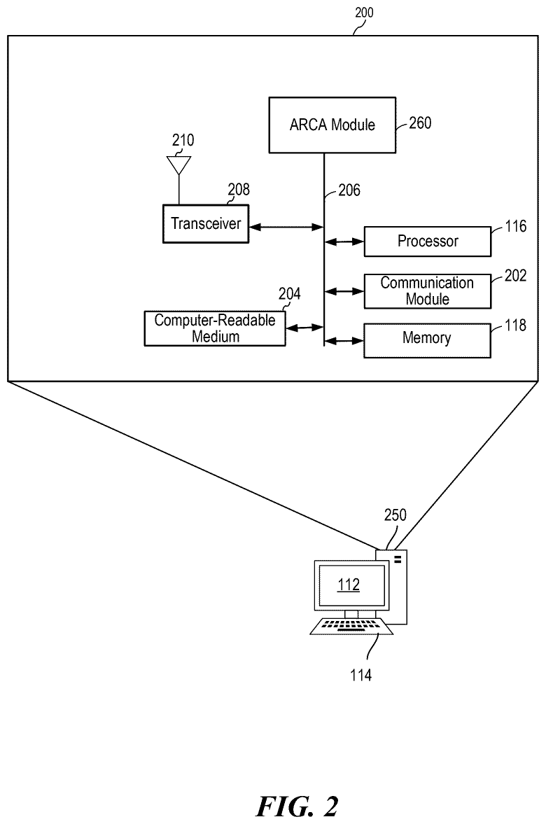

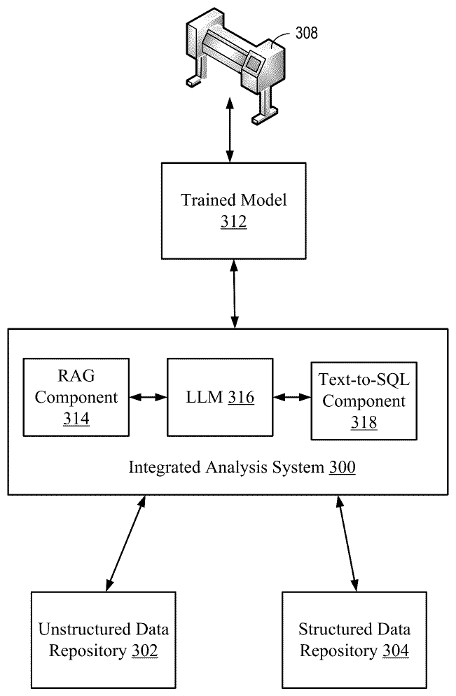

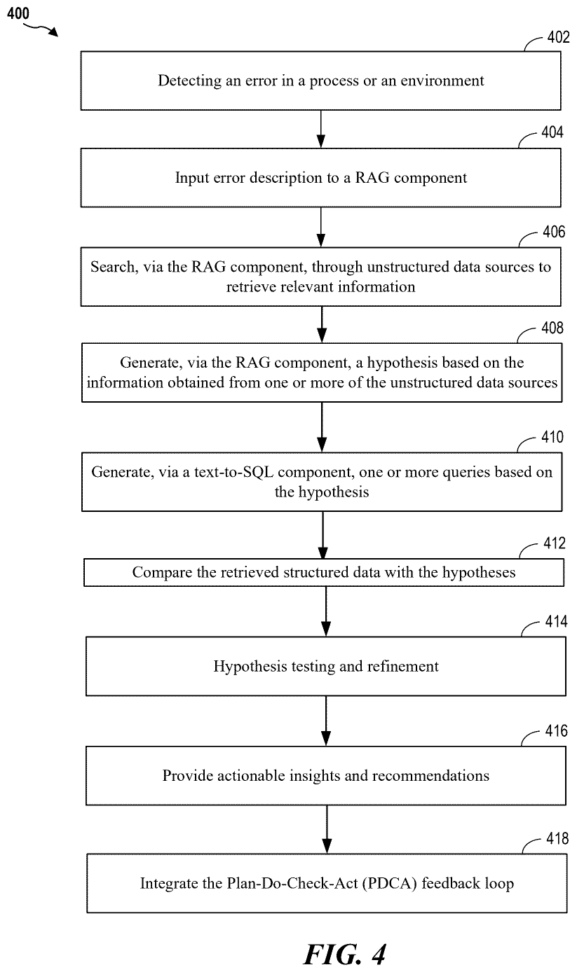

The server 120 may be maintained by a system administrator and included inside a housing that contains components of the server 120, such as one or more processors 116 and a memory 118. The housing may also include, or be connected to, a display 112 and an input device 114, which may be interconnected with other components of the server 120. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 120 may execute instructions for searching structured and/or unstructured data sources, and performing automated root cause analysis, in accordance with various aspects of the present disclosure. In some examples, the processor 116 of the server 120 is configured to perform operations and implement one or more elements associated with one or more processes, such as the process 400 described with respect to FIG. 4. Additionally, or alternatively, the processor 116 of the server 120 may be configured to perform operations associated with the ARCA module 260 described with reference to FIG. 2.

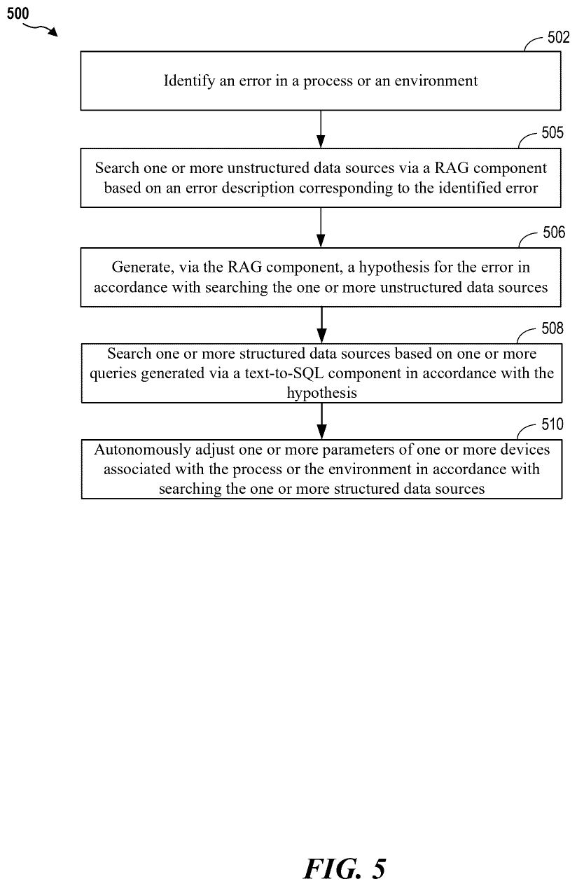

FIG. 2 is a diagram illustrating an example of a hardware implementation for a system 200, according to various aspects of the present disclosure. The system 200 may be a component of a device 250 for ARCA. The device may also be referred to as an ARCA device 250 (hereinafter used interchangeably). The system 200 may be an example of an integrated analysis system. The device 250 may be an example of a user device 110 or a server 120 described with reference to FIG. 1. As shown in the example of FIG. 2, the device 250 may include a display 112 and an input device 114 (e.g., a keyboard). In some examples, one or more modules of the system 200 may be configured to perform operations and implement one or more elements associated with one or more processes, such as the process 400 described with reference to FIG. 4 and/or the process 500 described with reference to FIG. 5.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

As shown in the example of FIG. 2, the system 200 may include a ARCA module 260 for searching structured and/or unstructured data sources, and/or performing automated root cause analysis (ARCA), in accordance with various aspects of the present disclosure. In some examples, the ARCA module 260 may perform one or more operations such as the operations described with reference to process 400 described with reference to FIG. 4. The ARCA module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the ARCA module 260 to implement one or more elements associated with one or more processes, such as the process 600 described with respect to FIG. 6. The computer-readable medium 204 may also be used for storing data that is manipulated by the processor 116 when executing the software. For example, working in conjunction with one or more of the other modules the modules 116, 118, 202, 204, and 208, the ARCA module 260 may perform operations, including operations of the process 400 described with reference to FIG. 4 and/or the process 500 described with reference to FIG. 5.

As indicated above, FIGS. 1 and 2 are provided as examples. Other examples may differ from what is described with regard to FIGS. 1 and 2.

Automated Root Cause Analysis (ARCA) is a highly sought-after advancement in manufacturing operations. An effective ARCA system autonomously analyzes defects or failures in production processes and provides actionable corrective measures, eliminating the need for human experts to manually interpret disparate data sources and identify root causes. In addition to diagnosing manufacturing defects and recommending corrective actions, an ARCA system may autonomously execute the corrective measures it identifies. For instance, upon determining that incorrect temperature settings in a machine are the root cause of a defect, the ARCA system could recalibrate the machine's temperature to the optimal setting without human intervention. Similarly, the system could automatically adjust production line speeds, modify pressure settings, or initiate maintenance protocols, such as shutting down faulty equipment or reconfiguring production workflows.

This autonomous capability to both diagnose and implement corrective actions significantly enhances the system's utility by minimizing downtime and reducing the need for manual oversight. With real-time monitoring and automatic adjustments, the system can continuously optimize manufacturing processes, correct defects, and prevent future issues from arising. This closed-loop approach improves operational efficiency, allows for precise control over manufacturing systems, reduces human error, and ensures consistent product quality across production cycles.

In modern manufacturing environments, large volumes of structured and unstructured data are generated. Structured data typically includes machine sensor readings, process parameters, and quality control metrics, which are systematically organized and stored in databases. Unstructured data, on the other hand, consists of expert notes, equipment manuals, and troubleshooting documents that are not organized in a predefined format, making them more difficult to search and analyze.

In conventional systems, separate tools are often used to retrieve relevant information from structured data sources (e.g., databases) and unstructured data sources (e.g., expert insights). A human operator must manually bridge the gap between these tools by reading through the unstructured data, forming a hypothesis, and querying structured data sources to validate the hypothesis. This manual process is time-consuming, requires significant expertise, and often leads to inefficiencies.

Conventional systems lack the capability to seamlessly integrate both structured and unstructured data sources for autonomous root cause analysis. Specifically, these systems are unable to analyze unstructured text and combine it with structured datasets to determine the most likely causes of manufacturing defects and recommend appropriate corrective actions. Successfully merging these data types into a unified analytical framework is essential to achieving fully autonomous problem diagnosis and resolution. Without such an integrated system, the goal of fully autonomous root cause analysis remains unattainable.

Furthermore, human operators face several limitations when attempting to process both structured and unstructured data sources. They may be overwhelmed by the sheer volume of data from numerous sources, face difficulties due to inconsistencies between structured and unstructured data, and require specialized domain knowledge to accurately interpret the results. Manual processes are also prone to human error, and the iterative nature of hypothesis testing and data gathering can be slow and inefficient, further hindering timely and effective problem-solving.

Various aspects of the present disclosure are directed to an integrated analysis system that automates root cause analysis by using a unified process to analyze structured and unstructured data. In some examples, the system may use a trained model to autonomously search unstructured documents, generate a hypothesis, and validate the hypothesis via structured data without the need for manual intervention.

Additionally, in some such examples, the trained model may use retrieval-augmented generation (RAG) to search through vast amounts of unstructured data, such as expert notes, equipment manuals, troubleshooting guides, and other textual information that lacks a predefined format. RAG combines the capabilities of information retrieval with natural language generation, enhancing the performance of large language models (LLMs), such as GPT-4. Using RAG, the integrated analysis system first retrieves relevant information from external data sources, such as databases, document repositories, or knowledge bases. These external data sources may store unstructured data, such as, such as manuals, reports, or articles. Still, the external data sources may also include some structured data. The retrieval step is used to find the most pertinent information that addresses a query or problem.

Once the relevant information is retrieved, the integrated analysis system then uses a language model to generate a coherent and contextually accurate response. The model synthesizes the retrieved data with its own understanding of the language to provide a well-formed answer. This approach combines the strengths of information retrieval and text generation, allowing the model to access more up-to-date and domain-specific information, which may not be part of its original training data.

RAG may improve accuracy because data may be obtained from specific external sources rather than relying solely on the model's pre-existing knowledge. RAG also provides context-aware responses, making RAG useful in scenarios that integrate complex information from multiple sources. In practice, RAG may be beneficial in particular environments, such as manufacturing, where technical queries can be addressed by retrieving relevant troubleshooting guides, historical data, or equipment logs, and then generating a tailored solution based on that data. Still, aspects of the present disclosure are not limited to RAG for gathering data from the unstructured data sources. Various aspects of the present disclosure may use other techniques for processing large-scale data.

By using advanced natural language processing techniques, the integrated analysis system may analyze the unstructured data, extract relevant information, and generate potential explanations or hypotheses for the observed issues. Aspects of the present disclosure are not limited to formulating one hypothesis. In some examples, multiple hypotheses may be formulated. For ease of explanation, the examples of the present disclosure may be limited to a single hypothesis. For instance, in response to a user input regarding a manufacturing defect, such as “low battery cell capacity,” a RAG component of the integrated analysis system may identify relevant information from technical manuals or historical troubleshooting records, suggesting possible causes such as suboptimal electrode thickness or improper material handling procedures.

Additionally, in some examples, the integrated analysis system uses a text-to-SQL component (e.g., text-to-SQL engine) to process structured data, allowing the integrated analysis system to access large and complex databases, such as those found in manufacturing execution systems (MES). The text-to-SQL engine is a computational system that converts natural language inputs into structured SQL queries, facilitating the retrieval of specific data from large-scale relational databases. The engine is equipped with advanced natural language processing (NLP) capabilities that allow it to interpret user-provided inputs in the form of questions or commands, such as “Retrieve all temperature readings from the assembly line in June,” and generate a corresponding SQL query tailored to the underlying database schema. This engine parses the natural language input, extracts relevant parameters such as time frames, data types, and conditions, and maps those parameters to the appropriate tables, fields, and relationships within the database.

The text-to-SQL engine effectively bridges the gap between users who may lack technical expertise in query languages and the complex data stored in structured formats. By automating the query formulation process, the engine ensures efficient and accurate data retrieval, eliminating the need for manually generating SQL queries. That is, SQL queries generated by humans may be incorrect or yield inaccurate results. This results in a user having to generate several SQL queries and run corresponding searches to obtain an accurate result. This process increases computational load and energy consumption. In contrast, SQL queries generated by the text-to-SQL engine reduce retrieval errors, which thereby reduces computational load and energy consumption. The text-to-SQL engine is particularly advantageous in scenarios where data is spread across multiple tables or where the database structure is complex, as the text-to-SQL engine can intelligently optimize queries to retrieve relevant information while minimizing computational load. This not only accelerates data access but also reduces the likelihood of errors typically associated with manual query writing, thereby improving the overall performance and accuracy of data-driven decision-making processes.

As discussed, structured data sources may include process parameters, such as sensor readings, machine settings, and quality control metrics. For example, in a manufacturing environment where thousands of data points may be collected across numerous machines and processes, the text-to-SQL engine can efficiently query specific parameters—such as temperature, pressure, or speed—based on an inquiry (e.g., hypothesis) generated by the RAG system. The inquiry may be human generated or generated by a model, such as a machine learning model trained to generate inquiries. The text-to-SQL engine interprets natural language queries, constructs appropriate SQL statements, and retrieves the relevant data, thereby enabling the system to validate or refute the hypothesis formed from the unstructured data.

By combining these two systems—RAG for unstructured data and text-to-SQL for structured data—the disclosed integrated analysis system creates an integrated framework for performing automated root cause analysis (ARCA). This integrated framework significantly reduces or eliminates the need for human intervention, allowing the system to autonomously form, test, and refine the hypothesis based on real-time and historical data. In one example, if the RAG system suggests that a manufacturing defect is due to low electrode thickness, the text-to-SQL engine may be used to retrieve historical process data related to electrode thickness measurements from specific production lines during a specified timeframe. The integrated analysis system then compares the retrieved data against industry standards or predefined thresholds to determine whether the hypothesized root cause is likely the source of the observed defect.

The integrated analysis system further improves its reasoning capabilities by incorporating a reasoning engine that performs advanced analysis and decision-making. This reasoning engine is designed to improve over time by utilizing feedback loops, including the Plan-Do-Check-Act (PDCA) methodology. The PDCA loop is a framework for continuous process improvement that may be used in manufacturing environments, for example. In this context, the integrated analysis system autonomously cycles through the PDCA loop. Specifically, the integrated analysis system generates a hypothesis based on available data, tests the hypothesis through structured data analysis, evaluates the results, and then acts by recommending (or autonomously performing) corrective actions or further testing. This iterative process allows the system to progressively refine its understanding of the manufacturing process and improve its root cause identification over time.

In some implementations, the system may use machine learning techniques to improve its hypothesis generation and validation processes. For example, the integrated analysis system may analyze past production data and identify patterns or anomalies that correlate with specific defects, thereby enabling more accurate predictions of root causes in future scenarios. Furthermore, the integrated analysis system can adapt to evolving manufacturing environments by learning from user interactions. For instance, if a human operator chooses to override the system's recommendation and provides feedback on the outcome, the integrated analysis system can incorporate this feedback into its decision-making process, improving its performance in subsequent analyses.

One of the advantages of the integrated analysis system is its ability to manage and process large-scale data without overwhelming the user. In conventional manufacturing systems, the sheer volume of data from various sources can make it challenging for human operators to identify relevant information and draw meaningful conclusions. More specifically, the data may be stored in various locations and in various formats. Some data formats, such as may not be readable by humans. Such data formats may include, but are not limited to, binary-encoded files, machine logs in hexadecimal format, raw sensor data stored in binary, compressed files including encoded data, and proprietary data formats generated by specific equipment. Various aspects of the present disclosure may narrow down the vast pool of data to only those elements that are relevant to the current analysis, significantly reducing the cognitive load on operators. Additionally, by autonomously identifying and validating potential root causes, the system reduces the risk of human error and ensures that decisions are based on data-driven insights rather than subjective judgment. Furthermore, various aspects of the present disclosure may decode and/or interpret (e.g., process) data formats that are not readable by humans.

Additionally, or alternatively, various aspects of the present disclosure may handle complex cross-domain data. For example, manufacturing environments often require the integration of diverse data sources, including mechanical, electrical, and chemical processes. The disclosed system's ability to incorporate unstructured documents, such as engineering notes and maintenance logs, alongside structured data from sensors and process control systems, enables it to perform comprehensive analyses that consider multiple factors and disciplines. This cross-domain analysis capability is particularly valuable in complex manufacturing environments where defects may result from the interaction of multiple variables, such as material properties, machine conditions, and operator behavior.

Furthermore, the integrated analysis system may support scalability and can be deployed across various manufacturing environments and industries. While the initial implementation may be tailored for specific manufacturing processes, such as battery production, the system's architecture is flexible enough to accommodate different types of production lines, materials, and equipment. This flexibility allows for customization based on the specific requirements of each factory, such that the integrated analysis system can provide relevant and accurate insights regardless of the industry or application.

In some aspects, the integrated analysis system can also generate actionable insights beyond root cause identification. For example, once a root cause has been identified and validated, the system may recommend corrective actions, such as adjusting machine settings, modifying the production process, or scheduling maintenance. The system can also generate reports that summarize the root cause analysis, data used for validation, and suggested actions, providing a comprehensive overview of the issue and its resolution. Additionally, or alternatively, the integrated analysis system may autonomously perform the recommended corrective action. For example, if the system identifies that an incorrect machine temperature setting is causing defects, it can autonomously recalibrate the machine to the optimal temperature. Similarly, if a pressure setting requires adjustment, the system may automatically alter the settings to fall within the ideal range. In cases where equipment maintenance is necessary, the system could initiate a maintenance protocol by notifying the relevant personnel, placing the equipment in standby mode, or scheduling downtime to avoid process interruptions. These autonomous adjustments ensure that production quality is maintained with minimal or no human intervention, reducing both response time and the potential for error. Additionally, the corrective action performed by the integrated analysis system may be more accurate than a corrective action performed by the human.

As discussed, various aspects of the present disclosure are directed to an integrated, autonomous approach to root cause analysis by combining AI-driven document analysis with structured data querying, enabling faster, more accurate problem-solving in manufacturing environments. By leveraging advanced reasoning capabilities and continuous improvement methodologies, such as the PDCA loop, the integrated analysis system not only identifies root causes but also provides actionable solutions, paving the way for more efficient and intelligent manufacturing processes.

FIG. 3 is a block diagram illustrating an example operation of an integrated analysis system 300 for automated root cause analysis (ARCA), in accordance with various aspects of the present disclosure. For ease of explanation, the example of FIG. 3 is described in conjunction with a simplified model based on a common 3D printing process. Specifically, the example of FIG. 3 is directed to using a 3D printing benchmark. In 3D printing, a benchmark model may be used to calibrate a 3D printer 308. The ARCA will incorporate both unstructured and structured data relevant to troubleshooting and improving the 3D printing process. The integrated analysis system 300 may be integrated with the 3D printer 308 or the integrated analysis system 300 may be a separate device, such as the device 250 described with reference to FIG. 2.

As shown in the example of FIG. 3, the integrated analysis system 300 may communicate with an unstructured data repository 302 that includes a variety of documents with troubleshooting advice for 3D printing and information on 3D printing benchmarks. The unstructured data repository 302 may include one or more data repositories. In some examples, one or more repositories may be a repository stored at the integrated analysis system 300. Additionally, or alternatively, one or more repositories of the unstructured data repository 302 may be external from the integrated analysis system 300. As an example, the unstructured data repository 302 may include one or more troubleshooting guides outlining common 3D printing issues, such as stringing and layer shifts, along with recommended solutions. Additionally, the unstructured data repository 302 may include community-driven advice from one or more online sources, such as the 3D printing subreddit (e.g., https://www.reddit.com/r/3DBenchy/), where contributors share real-world troubleshooting insights and solutions. The unstructured data repository 302 may further contain official benchmarking brochures, which include specifications and expected performance metrics for correctly printed 3D models. These brochures may be specifically tailored for one or more known benchmarks, such as the Benchy model. The unstructured data repository 302 may represent a collection of diverse data sources. In some implementations, one or more of these data sources may be a website or an online source. In such cases, data can be dynamically scraped from the website or other online repositories to ensure real-time updates are available for the analysis system.

Additionally, the integrated analysis system 300 may communicate with a structured data repository 304 that includes a variety of documents with troubleshooting advice for 3D printing and information on 3D printing benchmarks. The structured data repository 304 may include one or more repositories. In some examples, one or more repositories may be stored at the integrated analysis system 300. Additionally, or alternatively, one or more repositories of the structured data repository 304 may be external from the integrated analysis system 300. In such examples, the structured data repository 304 may include data, such as a GCode file used to generate the benchmark model on the 3D printer. This file contains key printing parameters, such as print speed, extrusion rate, bed temperature, and print head temperature. The GCode provides a detailed record of the printing process, which may be used to understand how the 3D printer was instructed to perform. Additionally, the structured data repository 304 may include direct sensor measurements from the 3D printer, capturing real-time data for the same parameters, such as, but not limited to, print speed, extrusion rate, bed temperature, and print head temperature. These measured variables allow for a comparison between what the GCode specifies and the actual conditions recorded during the print job.

Once the data is established in both the unstructured data repository 302 and structured data repository 304, a user 310 or a trained model 312 may interact with the integrated analysis system 300 by entering a description of the 3D printing error observed during the printing process. The trained model 312 may be integrated with the 3D printer 308 or may be integrated with a standalone device (not shown in the example of FIG. 3) that interacts with the 3D printer 308.

For example, a common 3D printing issue such as “spaghetti print” (where filament extrudes erratically, creating a tangled mess) or “problems with bed adhesion” (where the printed object does not stick properly to the print bed) may be specified. The integrated analysis system 300 may also assist by suggesting typical error descriptions for the user to select, streamlining the input process.

Additionally, or alternatively, a trained model 312 may autonomously report errors by directly providing descriptions to the integrated analysis system 300. For example, the trained model 312 may process sensor data to identify errors during the printing process. In some examples, the trained model 312 may use one or more sensors, such as a camera, to capture an image of the 3D printing output and upload a photograph of the defective print to provide visual context for further analysis. This process may involve the model 312 recognizing that a defect has occurred (e.g., by analyzing images from an on-printer camera) and automatically capturing and uploading a photo to the integrated analysis system 300. The photograph may improve the diagnostic capabilities of the integrated analysis system 300 by allowing the integrated analysis system 300 to visually compare the defective print with known examples of similar issues stored within the unstructured data repository 302, thereby aiding in the identification of root causes. In some examples, the integrated analysis system 300 may use a machine learning model, such as the trained model 312 or another model, to analyze the photograph to hypothesize on a root cause of an error, such as the error in the 3D printing output. This hypothesis may be the basis for further analysis of the unstructured data repository 302 and the structured data repository 304. In some examples, the user may upload the photograph to the integrated analysis system 300.

The ability to use visual data enables the integrated analysis system 300 to identify defects and/or errors that may not be evident to a human. For example, the trained model 312 may analyze the uploaded photograph to extract relevant visual features, such as uneven layers, excessive stringing, or gaps in the print. By combining the visual data with descriptions and existing structured data parameters (e.g., nozzle temperature, print speed), the trained model 312 may improve both the accuracy and reliability of error reporting and troubleshooting within the ARCA framework.

Once an error description is formulated, a retrieval-augmented generation (RAG) component 314 of the integrated analysis system 300 may then search through the unstructured document repository using the error description. As discussed, the error hypothesis may be generated by a human and/or a machine learning model, such as the trained model 312. For example, for 3D printing, the error description may be “stringing” (thin, hair-like strands of filament between details). In this example, the RAG component 314 may search to unstructured data repository 302 to retrieve relevant sections from the unstructured data, such as, but not limited to, troubleshooting guides or community posts addressing similar problems. A language model (LLM) 316 associated with the RAG component 314 may read the data retrieved from the unstructured data repository 302 to formulate a hypothesis about the root cause of the observed defect (e.g., error). In the 3D printing example, based on the data retrieved from the unstructured data repository 302, the LLM 316 may hypothesize that stringing is likely due to a nozzle temperature that is too high or retraction settings that are incorrect. The LLM 316 may provide explanations for its hypothesis based on the retrieved documents.

Based on the hypothesis, the integrated analysis system 300 may formulate a text-to-SQL query to query the structured data repository 304 to retrieve data corresponding to the nozzle temperature. The text-to-SQL query may be formulated by a text-to-SQL query component 318. For example, the text-to-SQL query component 318 may formulate a query to obtain GCode parameters and real-time measurements from the printer based on the hypothesis. A component of the integrated analysis system 300, such as the LLM 316, may then check the nozzle temperature set in the GCode, compare the nozzle temperature from the GCode with the measured nozzle temperature during the print, and evaluate both against standard recommended nozzle temperatures for the printing material being used. The integrated analysis system 300 may ask follow-up questions from the user or query a device in the manufacturing process for additional information. For example, the integrated analysis system 300 may ask the user, “What material are you printing?” to further refine its analysis, as the ideal nozzle temperature may vary by material type.

In some examples, the LLM 316 may be further trained with example question-answer pairs or other tools that improve its reasoning for this specific printing process. This technique, known as chain of thought reasoning, enhances an ability of the LLM 316 to consider multiple factors when diagnosing issues and generating solutions. For example, if inconsistencies are found between the GCode, the measured values, and the recommended standards, the integrated analysis system 300 may display these findings to the user. For example, the integrated analysis system 300 might inform the user that the nozzle temperature is higher than the standard, which could be causing the stringing issue. Additionally, if the GCode file is available, the integrated analysis system 300 may automatically rewrite the GCode to implement a potential fix. In the case of an overheated nozzle, the integrated analysis system 300 may adjust the GCode to lower the nozzle temperature and suggest this new configuration to the user as a solution.

Finally, after applying the recommended fix and printing again, the integrated analysis system 300 may receive feedback indicating whether the solution resolved the issue. This feedback is then incorporated into an example library of the integrated analysis system 300, allowing the LLM 316 to refine its future analyses and improve its performance for similar defects, effectively creating a self-learning ARCA system.

FIG. 4 is a flow diagram illustrating an example of a process 400 for automated root cause analysis (ARCA) using an integrated analysis system, in accordance with various aspects of the present disclosure. The process 400 may be implemented by an integrated analysis system, such as the integrated analysis system 300 described with reference to FIG. 3. As shown in the example of FIG. 4, the process 400 begins at block 402 by detecting an error in a process or an environment, such as a manufacturing environment. The error may be detected by a human and/or a trained model. The error may be associated with an error description that is formulated by the user and/or the trained model. For example, the error description may be “low battery capacity” or “sensor malfunction.” In some examples, the user may provide the integrated analysis system raw data inputs such as sensor readings, error logs, or photographic evidence of the defect. This input may be in the form of natural language or other data formats. A model, such as an LLM and/or other AI-model, associated with integrated analysis system interprets the input and generates the error description. The integrated analysis system may have flexibility in identifying a broad range of issues within the manufacturing environment by allowing diverse forms of input.

At block 404, the error description may be input to a RAG component. At block 406, the RAG component searches through unstructured data sources to retrieve relevant information. In some examples, the RAG component accessing and analyzing textual data that lacks a predefined format, such as equipment manuals, maintenance logs, troubleshooting guides, and expert notes. For example, if the input problem is “low battery capacity,” the RAG component may search documents related to battery production to identify known causes for such defects. The RAG component may use natural language processing (NLP) to extract the most relevant sections of the documents, which may include historical examples of similar defects and potential solutions. The ability to scan vast amounts of unstructured data quickly allows the system to provide insights that would otherwise require extensive human effort. Furthermore, the RAG component may search unstructured data sources that are not available to humans and/or unstructured data sources with data that is not in human-readable form.

At block 408, the RAG component generates a hypothesis based on the information obtained from one or more of the unstructured data sources, at block 406. Specifically, the information obtained from one or more of the unstructured data sources may be analyzed to formulate one or more hypotheses regarding the root cause of the problem. For example, if RAG component identifies several instances where electrode thickness issues were correlated with low battery capacity, the RAG component may hypothesize that improper electrode thickness is a potential cause of the current defect. The hypothesis generation process may involve multiple hypotheses being formed simultaneously, allowing RAG component to consider various possibilities. The RAG component system may also rank these hypotheses based on the likelihood or relevance to the data it has gathered. A model, such as an LLM and/or other type of AI-model, associated with the RAG component may formulate the hypotheses.

At block 410, a text-to-SQL engine (e.g., text-to-SQL component) may generate one or more queries based on the hypothesis. The hypothesis may be used to query relevant structured data. For example, the text-to-SQL engine may access one or more databases where structured data is stored, such as manufacturing execution system (MES) or sensor logs. The text-to-SQL engine translates natural language queries into structured queries, such as SQL statements, which allow the text-to-SQL engine to retrieve specific data from the structured databases. For example, the text-to-SQL engine may retrieve electrode thickness measurements over a certain time frame, or it may request temperature and pressure data from specific machines involved in the manufacturing process. This structured data is necessary for validating the hypotheses formed from the unstructured data.

At block 412, the process 400 performs data comparison and validation by comparing the retrieved structured data with the hypothesis. For example, the process 400 may compare the electrode thickness measurements retrieved by the text-to-SQL engine with known optimal ranges for the production process. The process 400 may also cross-reference sensor readings with historical data to detect anomalies or deviations from expected performance. The process 400 may identify whether the structured data supports or contradicts the hypotheses. For example, if the electrode thickness is consistently below the recommended range during the period when low battery capacity was observed, this would validate the hypothesis that the electrode thickness is causing the issue.

At block 414, after comparing the data, the process 400 may engage in hypothesis testing and refinement. For example, if a hypothesis is supported by the structured data, the system confirms the hypothesis as a probable root cause. However, if the data does not support any of hypotheses or provides inconclusive results, the process 400 refines the hypothesis or generates additional queries to gather more data. This iterative process of refining the hypotheses and testing against data ensures that the system continually hones in on the most likely root cause. For example, the process 400 may expand its analysis to include other factors, such as machine calibration data, operator input, and/or environmental conditions, if the initial hypothesis for the cause of the error was not accurate.

At block 416, once the hypothesis has been validated through data comparison, the process 400 provides the user and/or a device associated with the process 400 with actionable insights and recommendations. For example, the process 400 may provide one or more solutions based on the validated root cause. For example, if the process 400 determines that low electrode thickness is the issue, the process 400 may recommend adjusting the production parameters for the affected machines or scheduling immediate maintenance. The process 400 may also generate modified machine settings, recalibration suggestions, or process adjustments, and the process 400 can deliver these recommendations in a structured report format. Additionally, the process 400 can automatically generate revised SQL queries or scripts that will directly implement changes in the production process if integration with factory control systems is enabled.

At block 418, the process 400 may integrate the plan-do-check-act (PDCA) feedback loop, which allows the process 400 to learn from its interactions and continuously improve its problem-solving capabilities. That is, after implementing the recommended actions, the process 400 monitors the results and gathers feedback on whether the proposed solution resolved the issue. If the problem persists or new data emerges, the process 400 re-enters the PDCA cycle by forming a new hypothesis and performing additional analysis. This continuous feedback loop ensures that the process 400 evolves over time, becoming more accurate and efficient at identifying root causes and suggesting effective solutions in future scenarios. The PDCA loop also allows the system to adapt to changing production conditions or new manufacturing processes, making it highly scalable and applicable to a wide range of industries.

FIG. 5 is a flow diagram illustrating an example of a process 500 for automated root cause analysis (ARCA) using an integrated analysis system, in accordance with various aspects of the present disclosure. The process 500 may be implemented by an integrated analysis system, such as the integrated analysis system 300 described with reference to FIG. 3. As shown in FIG. 5, the process 500 begins at block 502 by identifying an error in a process or an environment. The error may be identified, via a machine learning model, based on one or more images, one or more sensor readings, and/or data associated with the process or the environment.

At block 504, the process 500 searches one or more unstructured data sources via a RAG component based on an error description corresponding to the identified error. The error description may be a natural language error description, which can be generated by the machine learning model. The unstructured data sources may include device manuals, notes, troubleshooting guides, and/or online community forums.

At block 506, the process 500 generates, via the RAG component, a hypothesis for the error in accordance with searching the one or more unstructured data sources. In some examples, the RAG component uses a large language model to generate the hypothesis.

At block 508, the process 500 searches one or more structured data sources based on one or more queries generated via a text-to-SQL component in accordance with the hypothesis. The structured data sources may include parameters associated with one or more devices, sensor data, machine logs, and/or production data.

At block 510, the process 500 autonomously adjusts one or more parameters of one or more devices associated with the process or the environment in accordance with searching the one or more structured data sources. In some examples, the process 500 includes retrieving structured data from the one or more structured data sources and comparing the retrieved structured data with the hypothesis. The autonomous adjustments may be based on the comparison of the retrieved structured data with the hypothesis.

In some examples, the process 500 is performed in the context of a manufacturing process and a manufacturing environment. The process 500 may also include generating a natural language error description via the machine learning model or using sensor data and logs to assist in identifying the error. By combining structured and unstructured data analysis, the process 500 provides a robust and automated method for root cause analysis and correction.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “and/or” refers to any combination of items, including single members. As an example, “a, b, and/or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for automated root cause analysis via one or more structured data sources and one or more unstructured data sources, comprising:
identifying an error in a process or an environment;
searching, via a retrieval-augmented generation (RAG) component, the one or more unstructured data sources in accordance with an error description corresponding to the identified error;
generating, via the RAG component, a hypothesis for the error in accordance with searching the one or more unstructured data sources;
searching the one or more structured data sources in accordance with one or more queries generated via a text-to-SQL component in accordance with the hypothesis;
autonomously adjusting one or more parameters of one or more devices associated with the process or the environment in accordance with searching the one or more structured data sources.

2. The method of claim 1, wherein the error is identified, via a machine learning model, based on one or more images, one or more sensor reading, and/or data associated with the process or the environment.

3. The method of claim 2, wherein:
the error description is a natural language error description; and
the machine learning model generates the natural language error description.

4. The method of claim 1, wherein the RAG component generates the hypothesis via a large language model.

5. A method of claim 1, wherein:
the one or more structured data sources include parameters associated with the one or more devices, sensor data, machine logs, and/or production data; and
the one or more unstructured data sources include device manuals, notes, troubleshooting guides, and/or online community forums.

6. The method of claim 1, further comprising:
retrieving structured data from the one or more structured data sources in accordance with searching the one or more structured data sources; and
comparing the retrieved structured data with the hypothesis, wherein the one or more parameters are autonomously adjusted based on the comparison of the retrieved structured data with the hypothesis.

7. The method of claim 1, wherein the process is a manufacturing process and the environment is a manufacturing environment.

8. An apparatus for automated root cause analysis via one or more structured data sources and one or more unstructured data sources, comprising:
one or more processors; and
one or more memories coupled with the one or more processors and storing processor-executable code that, when executed by the one or more processors, is configured to cause the apparatus to:
identify an error in a process or an environment;
search, via a retrieval-augmented generation (RAG) component, the one or more unstructured data sources in accordance with an error description corresponding to the identified error;
generate, via the RAG component, a hypothesis for the error in accordance with searching the one or more unstructured data sources;
search the one or more structured data sources in accordance with one or more queries generated via a text-to-SQL component in accordance with the hypothesis; and
autonomously adjust one or more parameters of one or more devices associated with the process or the environment in accordance with searching the one or more structured data sources.

9. The apparatus of claim 8, wherein the error is identified, via a machine learning model, based on one or more images, one or more sensor readings, and/or data associated with the process or the environment.

10. The apparatus of claim 8, wherein execution of the processor-executable code further causes the apparatus to:
search the one or more structured data sources to retrieve structured data; and
compare the retrieved structured data with the hypothesis, wherein the one or more parameters are autonomously adjusted based on the comparison of the retrieved structured data with the hypothesis.

11. The apparatus of claim 8, wherein the RAG component generates the hypothesis via a large language model.

12. The apparatus of claim 8, wherein the one or more structured data sources include parameters associated with the one or more devices, sensor data, machine logs, and/or production data, and the one or more unstructured data sources include device manuals, notes, troubleshooting guides, and/or online community forums.

13. The apparatus of claim 8, wherein the process is a manufacturing process and the environment is a manufacturing environment.

14. A non-transitory computer-readable medium having program code recorded thereon for automated root cause analysis via one or more structured data sources and one or more unstructured data sources, the program code executed by one or more processors and comprising:
program code to identify an error in a process or an environment;
program code to search, via a retrieval-augmented generation (RAG) component, the one or more unstructured data sources in accordance with an error description corresponding to the identified error;
program code to generate, via the RAG component, a hypothesis for the error in accordance with searching the one or more unstructured data sources;
program code to search the one or more structured data sources in accordance with one or more queries generated via a text-to-SQL component in accordance with the hypothesis; and
program code to autonomously adjust one or more parameters of one or more devices associated with the process or the environment in accordance with searching the one or more structured data sources.

15. The non-transitory computer-readable medium of claim 14, wherein the program code further comprises program code to identify the error, via a machine learning model, based on one or more images, one or more sensor readings, and/or data associated with the process or the environment.

16. The non-transitory computer-readable medium of claim 14, wherein:
the error description is a natural language error description; and
the machine learning model generates the natural language error description.

17. The non-transitory computer-readable medium of claim 14, wherein the program code further comprises program code to generate the hypothesis via a large language model.

18. The non-transitory computer-readable medium of claim 14, wherein:
the one or more structured data sources include parameters associated with the one or more devices, sensor data, machine logs, and/or production data; and
the one or more unstructured data sources include device manuals, notes, troubleshooting guides, and/or online community forums.

19. The non-transitory computer-readable medium of claim 14, wherein the program code further comprises
program code to retrieve structured data from the one or more structured data sources in accordance with searching the one or more structured data sources; and
program code to compare the retrieved structured data with the hypothesis, wherein the one or more parameters are autonomously adjusted based on the comparison of the retrieved structured data with the hypothesis.

20. The non-transitory computer-readable medium of claim 14, wherein the process is a manufacturing process and the environment is a manufacturing environment.
